(19) United States
(12) Patent Application Publication
(10) Pub. No.: US 2019/0191079 A1
(43) Pub. Date: Jun. 20, 2019

(54) CAMERA INITIALIZATION FOR A MULTIPLE CAMERA MODULE

(71) Applicant: QUALCOMM Incorporated, San Diego, CA (US)

(72) Inventors: Jignesh Mehta, San Diego, CA (US); Mridul Singh, San Diego, CA (US); Guruprasad Gaonkar, San Diego, CA (US); Pasi Johannes Parkkila, San Diego, CA (US); Satish Goverdhan, San Diego, CA (US)

(21) Appl. No.: 15/849,013

(22) Filed: Dec. 20, 2017

(51) Int. Cl. H04N 5/232

(52) U.S. Cl. CPC H04N 5/23225; H04N 5/247; H04N 5/23229

(57) ABSTRACT

Aspects of the present disclosure relate to systems and methods for camera initialization of a multiple camera module. An example device may include one or more processors and a memory including instructions that, when executed by the one or more processors, cause the device to receive a first command for initializing a first camera of a multiple camera module, receive a second command, after receiving the first command, for initializing a second camera of the multiple camera module, receive a third command, after receiving the second command, for initializing the first camera, and execute the first command and the third command before executing the second command.

### TECHNICAL FIELD

This disclosure relates generally to systems for image capture devices, and specifically to camera initialization for a multiple camera module.

### BACKGROUND OF RELATED ART

Many devices include or are coupled to a multiple camera module for capturing images and video. For example, smartphones may have a dual camera module with a primary camera and an auxiliary camera. A device typically initializes all cameras of a multiple camera module before using one camera to capture images and videos. The amount of time required for initializing all cameras of a multiple camera module before capturing an image or video may negatively impact a user experience. For example, a person wishing to use a smartphone to quickly capture a scene may press the camera app on the display and wait for the multiple camera module to initialize. As the person waits for the multiple camera module to initialize, the scene may change, the person may become impatient, or the person may attempt to press a camera shutter button to capture an image before the multiple camera module is initialized. What is needed is an improved camera initialization for multiple camera modules.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the present disclosure relate to systems and methods for camera initialization for a multiple camera module. In some example implementations, a device may include one or more processors, and a memory including instructions that, when executed by the one or more processors, cause the device to receive a first command for initializing a first camera of a multiple camera module, receive a second command, after receiving the first command, for initializing a second camera of the multiple camera module, receive a third command, after receiving the second command, for initializing the first camera, and execute the first command and the third command before executing the second command.

In another example, a method for initializing a multiple camera module including at least a first camera and a second camera is disclosed. The example method may include receiving a first command for initializing the first camera, receiving a second command, after receiving the first command, for initializing the second camera, receiving a third command, after receiving the second command, for initializing the first camera, and executing the first command and the third command before executing the second command.

In another example, a non-transitory computer-readable medium is disclosed. The non-transitory computer-readable medium may store instructions that, when executed by one or more processors of a device, cause the device to perform operations including receiving a first command for initializing a first camera of a multiple camera module, receiving a second command, after receiving the first command, for initializing a second camera of the multiple camera module, receiving a third command, after receiving the second command, for initializing the first camera, and executing the first command and the third command before executing the second command.

In another example, a device includes means for receiving a first command for initializing a first camera of a multiple camera module, means for receiving a second command, after receiving the first command, for initializing a second camera of the multiple camera module, means for receiving a third command, after receiving the second command, for initializing the first camera, and means for executing the first command and the third command before executing the second command.

### BRIEF DESCRIPTION OF THE DRAWINGS

Aspects of this disclosure are illustrated by way of example, and not by way of limitation, in the figures of the accompanying drawings and in which like reference numerals refer to similar elements.

FIG. 1 is a block diagram of example bridgeware to bridge operation of the operating system and operation of the multiple camera module.

FIG. 2 is a block diagram of an example device for initializing a multiple camera module.

FIG. 3 is a timing diagram of an example conventional initialization process of a multiple camera module.

FIG. 4 is an illustrative flow chart depicting an example operation for initializing a first camera of a multiple camera module.

FIG. 5 is an illustrative flow chart depicting another example operation for initializing a first camera of a multiple camera module.

FIG. 6 is a timing diagram of an example initialization process of a first camera of a multiple camera module.

### DETAILED DESCRIPTION

Aspects of the present disclosure may be used for initializing a camera of a multiple camera module. In some example implementations, a device may initialize and operate one camera of a multiple camera module before initializing all of the cameras of the multiple camera module. In this manner, the device may more quickly capture an image or video than waiting to initialize all cameras of a multiple camera module before capturing an image or video. For example, a device may initialize and begin using a primary camera of a dual camera module in order to generate a preview stream or capture images and video before the auxiliary camera of the dual camera module is initialized.

In some example implementations, devices may include or be coupled to a multiple camera module. For example, a smartphone or tablet may include a dual camera module. In some other example implementations, devices may control a separate multiple camera module. For example, a security system may control a multiple security camera module. The multiple camera module includes two or more cameras that may be oriented in a similar direction. Many devices include a dual camera module with a primary camera and an auxiliary camera. In some example implementations, the primary camera and the auxiliary camera have the same image capture capabilities (such as the same field of view, same type of camera sensor, and so on). In some other example implementations, the capabilities of the primary camera may be different than the capabilities of the auxiliary camera. In one example, the primary camera may have a larger field of view than the auxiliary camera (such as the primary camera including a wide view camera lens and the auxiliary camera including a telephoto camera lens). In another example, the primary camera sensor may capture color information while the auxiliary camera sensor captures only black and white information (e.g., the auxiliary camera may assist in capturing detail for the primary camera in low light scenes). In a further example, the primary camera sensor may capture more fidelity than the auxiliary camera sensor (e.g., the auxiliary camera may be used in determining the focus setting for the primary camera). The example camera configurations also apply for multiple camera modules with more than two cameras.

Example devices include digital cameras, smartphones, tablets, laptop computers, desktop computers, security systems, and so on. Many devices including or coupled to a multiple camera module, or to otherwise control a multiple camera module, include an operating system for operation. For example, a smartphone, a tablet, or a computer may include an operating system for a user to interact with the device and for the device to perform requested operations (such as word processing applications, texting, internet browsing, and so on). One or more applications included in or installed for the operating system may be a camera application for operating the multiple camera module. For example, a smartphone may include a camera application, which may be launched in response to a user tapping a camera app icon on a display of the smartphone. An operating system may be a layer of abstraction where general commands are translated into one or more specific commands for a device. For example, a camera application may provide a general “start camera” command for initializing a multiple camera module, which may be translated by the operating system into one or more general commands for initializing multiple cameras (such as commands for initializing a first camera and commands for initializing a second camera).

Different types of multiple camera modules exist, and different manufacturers may produce multiple camera modules. As a result, the command format, structure, and sequence may differ between different multiple camera modules. One or more camera applications may be used by the device in initializing and operating the multiple camera module. For example, opening a camera application may cause a command for initializing the multiple camera module (e.g., the “start camera” command). The operating system may include a hardware abstraction layer (HAL) to allow programmers to define basic commands that are then translated by the HAL into general commands for the device. However, commands from an operating system may not be hardware specific. For example, an operating system may be installed on different types of devices from different manufacturers (and with different types of multiple camera modules). As a result, the commands from the operating system may be generic commands that are to be translated by one or more processors of a device into hardware or module specific commands.

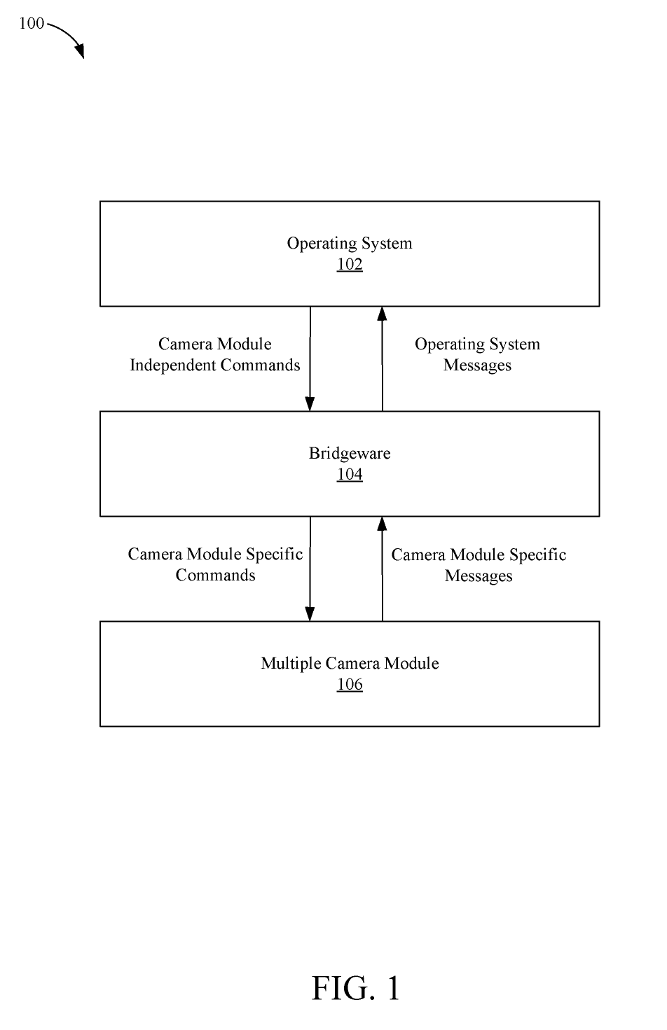

FIG. 1 is a block diagram 100 of an example bridgeware 104 to bridge operation of the operating system 102 and operation of the multiple camera module 106 for a device. In one example, bridgeware 104 may be one or more drivers executed by one or more processors of a device. The one or more processors may use the bridgeware 104 (such as one or more drivers) to translate camera module independent commands from the operating system 102 to camera module specific commands for the multiple camera module 106.

The multiple camera module 106 may provide messages that are specific to the multiple camera module 106. For example, the messages may be in a format, structure, and sequence that is specific and different from other camera modules. In this manner, the bridgeware 104 may be used by the one or more processors to translate the camera module specific messages to operating system messages.

Before a multiple camera module is used for capturing images or video, the multiple camera module is initialized. For example, initializing the multiple camera module may include providing power to the cameras, initializing a data buffer for each camera, determining initial capture settings for each camera, and enabling a camera sensor with the initial capture settings for each camera. Initial capture settings for a camera may include a shutter speed, an aperture size, a camera sensor sensitivity, a focus setting (such as a focal length of the camera lens), and so on. Conventional devices typically perform all of the initialization steps for each and every camera of the multiple camera module before allowing one of the cameras to be used for image or video capture. For example, all cameras are initialized before a preview stream is provided to the user, which may impact the user experience in capturing images or video. In some example implementations, a device may initialize a camera of the multiple camera module so that the camera may be used to capture images or video (such as providing a preview stream) before performing all steps for initializing one or more of the other cameras of the multiple camera module. In this manner, one or more cameras of the multiple camera module may be initialized after one of the cameras begins operation.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure. Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory and the like.

Aspects of the present disclosure are applicable to any suitable electronic device configured to or capable of capturing images or video (such as a security system with two or more cameras, smartphones, tablets, laptop computers, digital video and/or still cameras, web cameras, and so on). While described below with respect to a device having or coupled to two cameras, aspects of the present disclosure are applicable to devices having any number of cameras greater than two, and are therefore not limited to devices having two cameras.

The term “device” is not limited to one or a specific number of physical objects (such as one camera controller, one processing system, and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects.

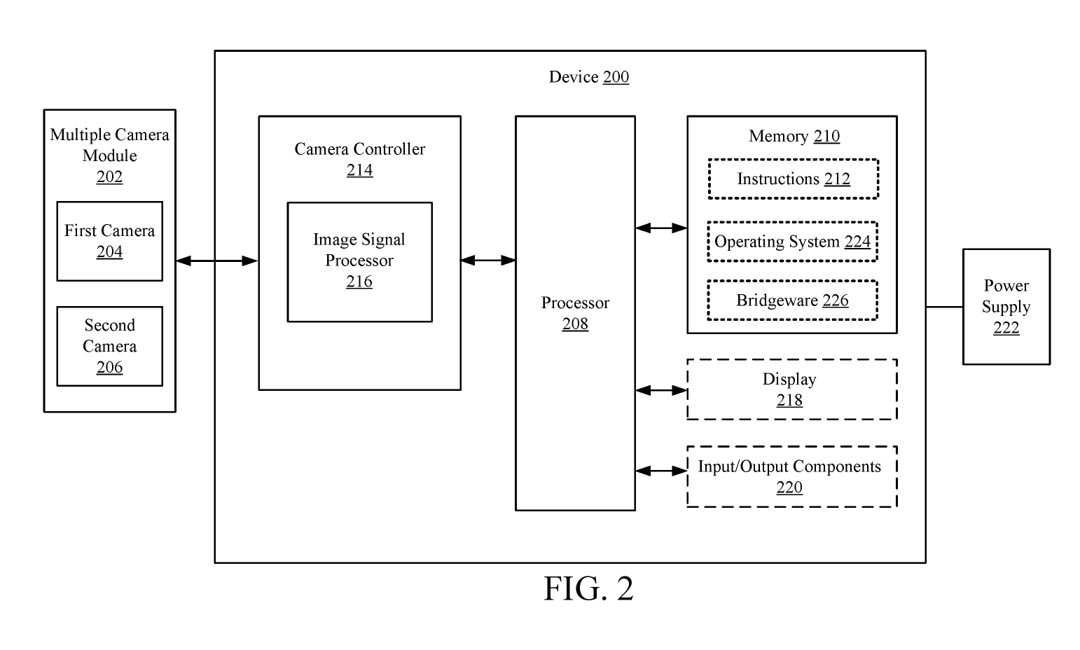

FIG. 2 is a block diagram of an example device 200 for initializing a multiple camera module 202 including a first camera 204 and a second camera 206. The multiple camera module 202 may be an example implementation of the multiple camera module 106 of FIG. 1. The example device 200 may include or be coupled to the multiple camera module 202, and may include a processor 208, a memory 210 storing instructions 212, and a camera controller 214. The device 200 may optionally include (or be coupled to) a display 218 and a number of input/output (I/O) components 220. The device 200 may include additional features or components not shown. For example, a wireless interface, which may include a number of transceivers and a baseband processor, may be included for a wireless communication device. Additionally, the device 200 may include or be coupled to additional cameras modules other than the multiple camera module 202. The disclosure should not be limited to any specific examples or illustrations, including the example device 200.

The multiple camera module 202 may be a dual camera module or any other suitable module with multiple camera sensors (such as a first camera sensor for the first camera 204 and a second camera sensor for the second camera 206). The multiple camera module 202 may also include separate shutters, aperture openings, power rails, control circuits, and so on for each of the cameras. While the multiple camera module 202 is shown to include the first camera 204 and the second camera 206, the multiple camera module may include three or more cameras.

The memory 210 may be a non-transient or non-transitory computer readable medium storing computer-executable instructions 212 to perform all or a portion of one or more operations described in this disclosure. The memory 210 may also include an operating system 224 including instructions or commands that may be executed by the processor 208 (or by the image signal processor 216) to control operation of the device 200. For example, the operating system 224 may include a camera application (not shown for simplicity) to provide commands to be executed by the processor 208 or by the image signal processor 216 for controlling the multiple camera module 202. The memory 210 may also include a bridgeware 226 to be used for translating one or more commands from the operating system 224 to hardware or module specific commands for the device 200. In some other example implementations, the operating system 224 and/or the bridgeware 226 may be stored in a different memory of the device, such as a memory coupled to the image signal processor 216 or a separate memory for startup of the device 200. The device 200 may also include a power supply 222, which may be coupled to or integrated into the device 200.

The processor 208 may be one or more suitable processors capable of executing scripts or instructions of one or more software programs stored within the memory 210. In some aspects, the processor 208 may be one or more general purpose processors that execute instructions 212 to cause the device 200 to perform any number of functions or operations. For example, the processor 208 may execute an operating system 224 and/or bridgeware 226 (which may be examples of the operating system 102 and the bridgeware 104 of FIG. 1) in converting or translating camera module independent commands to camera module specific commands. In additional or alternative aspects, the processor 208 may include integrated circuits or other hardware to perform functions or operations without the use of software. While shown to be coupled to each other via the processor 208 in the device 200, the processor 208, the memory 210, the camera controller 214, the optional display 218, and the optional I/O components 220 may be coupled to one another in various arrangements. For example, the processor 208, the memory 210, the camera controller 214, the optional display 218, and/or the optional I/O components 220 may be coupled to each other via one or more local buses (not shown for simplicity).

The display 218 may be any suitable display or screen allowing for user interaction and/or to present items (such as captured images, video, or a preview image) for viewing by a user. In some aspects, the display 218 may be a touch-sensitive display. The I/O components 220 may be or include any suitable mechanism, interface, or device to receive input (such as commands) from the user and to provide output to the user. For example, the I/O components 220 may include (but are not limited to) a graphical user interface, keyboard, mouse, microphone and speakers, and so on. The display 218 and/or the I/O components 220 may provide a preview image to a user and/or receive a user input for adjusting one or more settings of multiple camera module 202 or for capturing an image or video using the multiple camera module 202.

The camera controller 214 may include an image signal processor 216, which may be one or more image signal processors to process captured image frames provided by the multiple camera module 202. In some example implementations, the camera controller 214 (such as the image signal processor 216) may also control operation of the multiple camera module 202. For example, the camera controller 214 may control initializing the first camera 204 and the second camera 206 of the multiple camera module 202. In some aspects, the image signal processor 216 may execute instructions from a memory (such as instructions 212 from the memory 210 or instructions stored in a separate memory coupled to the image signal processor 216) to control operation of the multiple camera module 202 and to process image frames or video captured by the multiple camera module 202. For example, the image signal processor 216 may execute the bridgeware 226 for converting or translating camera module independent commands from the operating system 224 to camera module specific commands. In other aspects, the image signal processor 216 may include specific hardware to control operation of the multiple camera module 202 and/or to process image frames captured by the multiple camera module 202. The image signal processor 216 may alternatively or additionally include a combination of specific hardware and the ability to execute software instructions.

The device 200 may receive a general command from the operating system 224 (such as from the camera application) for initializing the multiple camera module 202. The hardware abstraction layer (HAL) of the operating system 224 may be used by the processor 208 or image signal processor 216 to convert or translate the general command into one or more commands for initializing the multiple camera module 202. The commands may include, for example, opening the first camera 204 (which may include providing power to the first camera 204), opening the second camera 206 (which may include providing power to the second camera 206), configuring the first camera 204 (which may include configuring the exposure value, white balance, and so on for the first camera 204), configuring the second camera 206 (which may include configuring the exposure value, white balance, and so on for the second camera 206), initializing a buffer or queue for the first camera 204 (which may be used to store capture information from the first camera 204 before being processed by the camera controller 214), initializing a buffer or queue for the second camera 206 (which may be used to store capture information from the second camera 206 before being processed by the camera controller 214), enabling a camera sensor for the first camera 204, and enabling a camera sensor for the second camera 206. While the commands may be more detailed than the general command from the camera application, the commands may not be module or hardware specific, and the bridgeware may be used to convert such commands to hardware or module specific commands.

A device may include and/or control hardware components from any of a plurality of manufacturers. For example, a first camera 204 and a second camera 206 may be part of a dual camera module that is provide by one of a plurality of manufacturers or vendors. The hardware from one manufacturer or vendor may require commands or command structures that are different than for another manufacturer or vendor. Different versions of hardware from the same vendor may also have different commands or command structures. In contrast, an operating system may be installed on a variety of devices with different hardware, and may be configured to support as many different devices as possible. Therefore, the operating system may need to be compatible with various types of hardware, which may require different commands or command structures. The operating system may also need to be compatible with future hardware and device configurations. If an operating system may provide general commands that may occur for all devices (such as configuring a first camera, configuring a second camera, and so on), the operating system may be compatible with current and future device configurations. However, the general commands may still be required to be converted to specific hardware or module commands or command structures.

If an operating system is hardcoded or otherwise always updated to provide module or hardware specific commands, the operating system may become power or resource intensive. For example, loading or processing libraries or scripts in the operating system may take longer as more are loaded for supporting more and more configurations and hardware, and storing more and more different command structures and loading scripts may require more memory than desired. Further, a manufacturer introducing a new device or hardware may require the company that provides the operating system to alter the operating system to process specific commands for the hardware. Changes to the operating system may require an undesirable delay, and some hardware manufacturers may ultimately be denied from being supported if no updates to the operating system are made. To prevent barriers of entry for hardware manufacturers and vendors, and to make an operating system more compatible with various devices without undue delay, bridgeware that couples to the operating system or receives and sends information from and to the operating system may be used to convert between the general commands of the operating system and the specific commands from the hardware module. For example, the operating system may include one or more software ports, or provide and receive the general commands in known data structures, for device manufacturers, device vendors, or others to create the bridgeware that can translate between the hardware specific commands and the operating system general commands without requiring additional updates for the operating system. In some example implementations, bridgeware may be one or more drivers executed by a device to receive commands from the operating system, convert the commands to hardware specific commands, and provide the hardware specific commands to the hardware. For example, a hardware component manufacturer (such as for a dual camera module) may develop the driver and provide to a device manufacturer when providing the hardware module. In this manner, the device manufacturer when building the device may include the operating system, the driver, and the hardware component, and insure compatibility without requiring changes in the operating system or requiring the company providing the operating system to make changes to support the specific hardware. As a result, the operating system may be a higher abstraction layer than bridgeware.

Referring again to FIG. 1, the operating system 102 may be a higher abstraction layer than the bridgeware 104. In this manner, the commands from the HAL of the operating system 102 (such as operating system 224) may be general commands that are not specific to the multiple camera module 202. The bridgeware 104 (such as bridgeware 226) may be executed by the processor 208 or image signal processor 216 of device 200 to convert the camera module independent commands to camera module specific commands (thus moving from an abstract layer for general commands to a layer for hardware specific commands). For example, a camera module independent command from the HAL to configure the exposure value for the first camera 204 of the multiple camera module 202 may be converted into one or more multiple camera module 202 specific commands using the bridgeware 226 to, for example, configure the specific camera shutter, the camera sensor sensitivity, and/or the aperture size for the first camera 204. The camera module specific commands may then be provided to the multiple camera module 202 during initialization of the multiple camera module 202.

When conventionally initializing a multiple camera module, a first camera and a second camera are both initialized before either camera is enabled for capturing an image. In one example, when a command is provided to the multiple camera module for the first camera, the next command is not provided to the multiple camera module until a response is received that the provided command is executed. As a result, a camera sensor is not activated and a preview from at least one of the cameras is not provided on a display of an associated device until all cameras of the multiple camera module are verified as initialized.

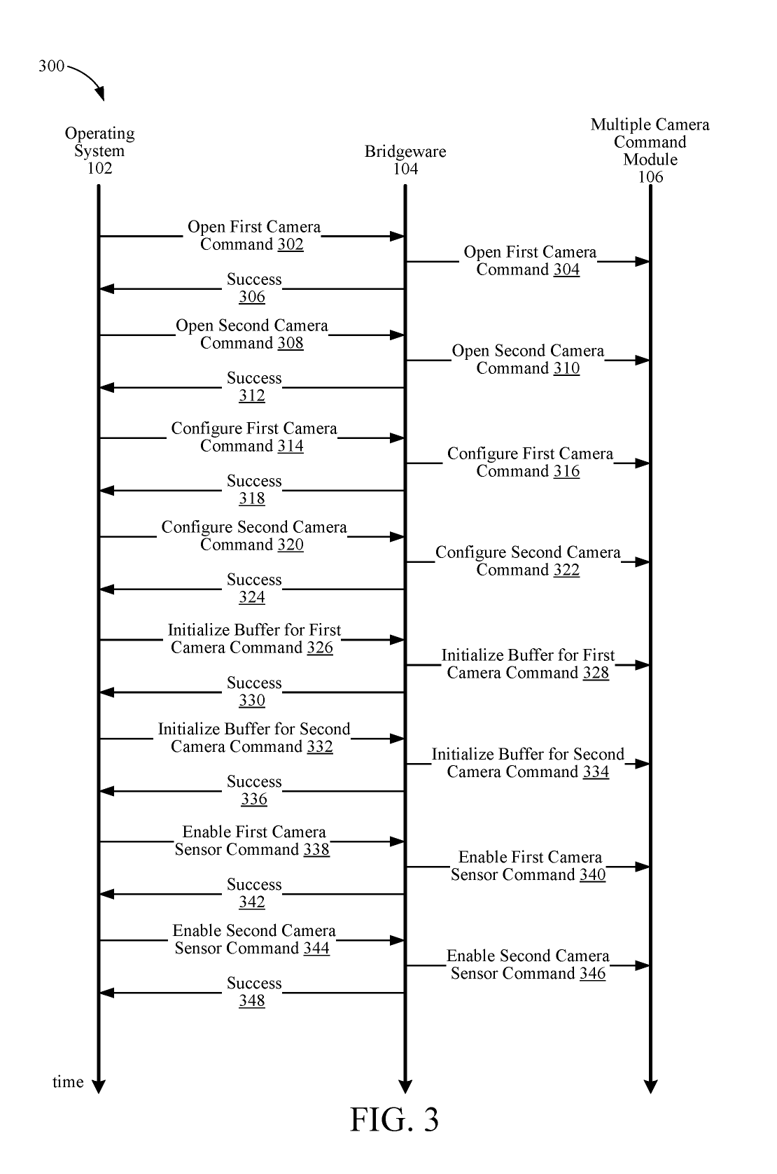

FIG. 3 is a timing diagram of an example conventional initialization process 300 of a multiple camera module. The initialization process 300 is described below with respect to communications between the operating system layer 102 and the bridgeware layer 104 of FIG. 1, where the operating system layer 102 is a higher abstraction layer of software than the bridgeware layer 104, and with respect to the example device 200 in FIG. for illustrative purposes. The commands from the operating system 102 to the bridgeware 104 are camera module independent commands. In this manner, the processor 208 and/or the image signal processor 216 may use the bridgeware 104 (such as bridgeware 226 of FIG. 2) to translate the camera module independent commands to commands specific to the multiple camera module 106 (such as the multiple camera module 202 of FIG. 2). In some example implementations, the processor 208 of the device 200 may execute the operating system 102, and the bridgeware 104 may be executed by the camera controller 214 (such as the image signal processor 216). In this manner, commands and messages may be provided between the processor 208 and the camera controller 214 during initialization of the multiple camera module 202. In some other example implementations, the processor 208 or the camera controller 214 (such as the image signal processor 216) may execute the operating system 102 and the bridgeware 104. In some other example implementations, one or more processes of the bridgeware 104 and/or the operating system 102 may be performed in hardware or a combination of hardware and software.

The operating system layer 102 may provide an open first camera command 302 to the bridgeware layer 104. The bridgeware 104 may then be used (such as by the processor 208 or the image signal processor 216) to convert the open first camera command 302 to one or more open first camera commands 304 specific to the multiple camera module 106. For example, the open first camera command 302 may be converted to an apply power command (such as providing power on one or more power rails), enabling commands for one or more controllers of a first camera 204, and so on. The one or more camera module specific commands for opening the first camera (such as the open first camera commands 304) may then be provided to the multiple camera module 106.

In some example implementations, if no error is received from the multiple camera module 106, a success message 306 is provided from the bridgeware layer 104 to the operating system layer 102. In some other example implementations, a success message is received from the multiple camera module 106 that indicates that the one or more open first camera commands 304 were successfully executed, and a success message 306 is provided from the bridgeware layer 104 to the operating system layer 102 in response to receiving the success message from the multiple camera module 106.

After providing the success message 306 that indicates a successful execution of the open first camera command 302, a next command for initializing the multiple camera module 106 may be received from the operating system layer 102. For example, an open second camera command 308 may be received from the operating system layer 102, and converted to one or more open second camera commands 310 using the bridgeware 104. The one or more open second camera commands 310 may then be provided to the multiple camera module 106. A success command 312 may be provided from the bridgeware layer 104 to the operating system layer 102 if the one or more open second camera commands 310 are successfully executed (such as by receiving a success message from the multiple camera controller or not receiving an error message from the multiple camera module 106).

The example operation for initializing the multiple camera module 106 may continue with one or more configure first camera commands 314 being received from the operating system layer 102 after the success message 312 is provided to the operating system layer 102. One or more example configure first camera commands 314 may include an exposure value, ISO, white balance, focal length, and target brightness for capturing images by a first camera (such as the first camera 204 in FIG. 2). In one example, a user may use a camera application for a manual mode, and the user may specify one or more camera settings. In another example, default camera settings from the camera application when initializing a camera are to be applied.

The processor 208 or the image signal processor 216 may use the bridgeware 104 to convert the user specified camera settings or the default camera settings for the first camera (such as the configure first camera command 314) to one or more camera module specific commands (such as the configure first camera command 316). For example, the bridgeware 104 may be used by the processor 208 or the image signal processor 216 to convert a default exposure value command from the operating system layer 102 to a camera shutter speed command, an aperture size command, and/or a camera sensitivity command for the first camera of the multiple camera module 106. The process may continue with a success message 318, a camera module independent configure second camera command 320, a camera module specific command 322, and a success message 324.

After providing the success message 324 in response to configuring the second camera of the multiple camera module 106, an initialize buffer for the first camera command 326 may be received from the operating system layer 102. The buffer may be used to temporarily queue information from the first camera 204 before being processed by the camera controller 214 (such as image signal processor 216). The buffer may be in or coupled to the multiple camera module 202. Alternatively, the buffer may be in or coupled to the camera controller 214 (such as a buffer coupled to the image signal processor 216). The one or more first camera buffer initialization commands 328 may be provided from the bridgeware layer 104 to the multiple camera module 106.

After the success message 330 is provided to the operating system layer 102, the second camera buffer may be initialized (such as by using the initialize buffer for the second camera commands 332 and 334, and the success message 336). After initializing the second camera buffer, the first camera sensor may be enabled (such as by using the enable first camera sensor commands 338 and 340, and the success message 342). After enabling the first camera sensor, the second camera sensor may be enabled (such as by using the enable second camera sensor commands 344 and 346, and providing the success message 348).

As shown in the initialization process 300, conventional initialization of the multiple camera module 106 (such as the multiple camera module 202 of the device 200) includes successful execution of a command before execution of a subsequent command. For example, the second camera 206 is successfully configured before the first camera buffer may be initialized. As a result, none of the cameras of the multiple camera module may be used (such as to generate a preview, to capture an image, and so on) until all of the cameras of the multiple camera module are initialized.

In some example implementations, a device may initialize and use a camera of a multiple camera module before all of the cameras of the multiple camera module are initialized. For example, the device 200 may initialize and begin using the first camera 204 to generate a preview and/or capture an image before initializing the second camera 206 of the multiple camera module 202. In this manner, the device 200 may not execute one or more commands for initializing the second camera 206 before executing subsequent commands for initializing the first camera 204. However, the operating system layer 102 may wait for a success message from the bridgeware layer 104 regarding execution of a previous command for initializing the second camera 206 before a subsequent command to initialize the first camera 204 is provided to the bridgeware layer 104.

In some aspects, the device 200 may provide a success message without executing the corresponding command. For example, the processor 208 or the image signal processor 216 may use the bridgeware 104 to provide the success message 312 indicating that the second camera 206 is successfully opened without providing the one or more open second camera commands 310 to the multiple camera module 202. In some example implementations, one or more commands for initializing the second camera 206 of the multiple camera module 202 may be stored and executed at a later time. In one example, one or more commands from an operating system 102 for initializing the second camera 206 may be placed into a buffer and executed after initialization of the first camera 204. In another example, the one or more buffered commands for initializing the second camera 206 may be executed when no command for initializing the first camera 204 is to be executed (such as the processor 208 or the image signal processor 216 is idle and has time to execute one or more commands before receiving another command for initializing the first camera 204).

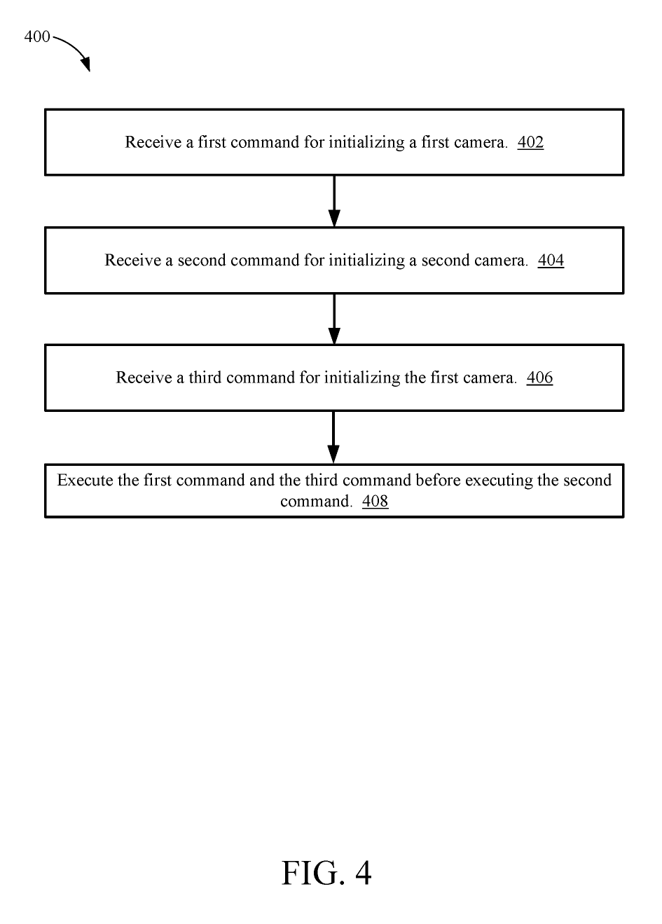

FIG. 4 is an illustrative flow chart depicting an example operation 400 for initializing the first camera 204 before initializing the second camera 206 of the multiple camera module 202. Beginning at 402, a first command for initializing a first camera may be received. For example, a camera module independent instruction of initializing the first camera 204 (FIG. 2) may be received from the operating system layer 102 (FIG. 1). Example first commands include commands 302, 314, and 326 of FIG. 3.

After receiving the first command (402), a second command for initializing a second camera may be received (404). For example, a camera module independent instruction of initializing the second camera 206 (FIG. 2) may be received from the operating system layer 102 (FIG. 1). Example second commands include commands 308, 320, or 332 for a first command 302, commands 320 or 332 for a first command 314, and command 332 for a first command 326 of FIG. 3.

After receiving the second command (404), a third command for initializing the first camera 204 may be received (406), and the first command and the third command for initializing the first camera may be executed before executing the second command for initializing the second camera (408). For example, if open first camera command 302 in FIG. 3 is the first command, the open second camera command 308 in FIG. 3 is the second command, and the configure first camera command 314 in FIG. 3 is the third command, commands 302 and 314 for the first camera may be executed before executing command 308 for the second camera. In some example implementations, the second command may be buffered, and the third command may be received and executed while the second command is buffered. For example, the configure first camera command 314 may be received and executed while the open second camera command 308 is buffered. To buffer, the processor 208, the image signal processor 216, and/or the multiple camera module 202 may include one or more buffers for storing the instructions to be executed at a later time. The buffer may be a first-in-first-out (FIFO) buffer or a queue to preserve the order of the commands to be executed in initializing the second camera 206. In this manner, the commands for initializing the multiple camera module 202 may be executed out of order to initialize and use the first camera 204 before initializing the second camera 206 of the multiple camera module 202. In some example implementations, executing a command may include translating a camera module independent command (such as from an operating system layer 102) into one or more camera module specific commands, and providing the one or more camera module specific commands to the multiple camera module 202. Additionally or alternatively, executing a command may include executing one or more multiple camera module specific commands.

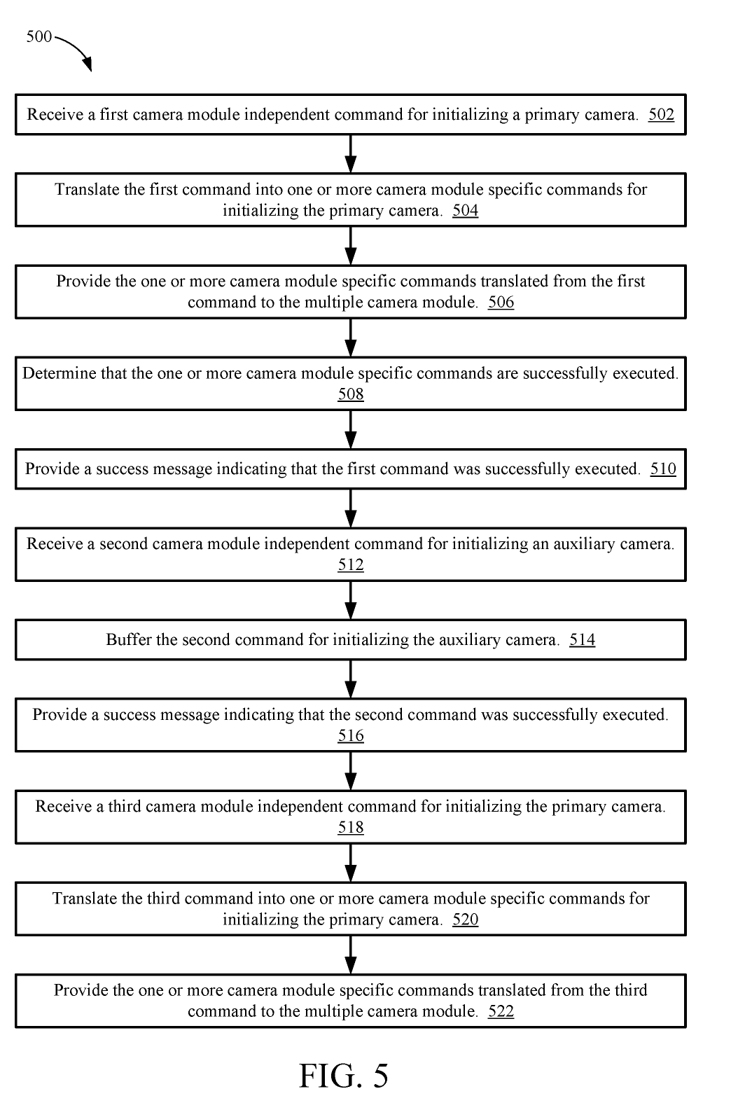

FIG. 5 is an illustrative flow chart depicting another example operation 500 for initializing the first camera 204 before initializing the second camera 206 of the multiple camera module 202. In some example implementations, the first camera 204 is a primary camera and the second camera 206 is an auxiliary camera of the multiple camera module 202. Beginning at 502, a first camera module independent command for initializing a primary camera (such as the first camera 204 of the multiple camera module 202) is received. The received first command is then translated (such as by the processor 208 or the image signal processor 216 executing the bridgeware 104) into one or more commands specific to the multiple camera module 202 for initializing the primary camera 204 (504).

After translating the received first command (504), the one or more commands specific to the multiple camera module 202 may be provided to the multiple camera module 202 for implementation (506). Additionally or alternatively, one or more of the camera module specific commands may be intended for the camera controller 214 (such as the image signal processor 216). For example, one or more of the commands may be for configuring one or more filters of the image signal processor 216. In this manner, the primary camera 204 of the multiple camera module 202 and the camera controller 214 may be configured using the one or more camera module specific commands.

After providing the one or more camera module specific commands for initializing the primary camera 204 (506), the one or more camera module specific commands are determined to be successfully executed (508). In one example, a success message or other indication may be received from the multiple camera module 202 to indicate that the one or more commands were successfully executed. In another example, the camera controller 214 may verify that the commands are successfully executed. In a further example, the camera controller does not receive an error message from the multiple camera module 202 after providing the camera module specific commands.

After determining successful execution of the one or more commands, a success message or other indication may be provided to the operating system layer 102 indicating that the first command from the operating system layer 102 for initializing the primary camera 204 was successfully executed (510). In response to providing a success message (510), a second camera module independent command for initializing an auxiliary camera (such as the second camera 206 of the multiple camera module 202) may be received from the operating system layer 102 (512). The second command may be buffered (514) for later execution (such as translation and execution of the one or more camera module specific commands).

The operating system 102 may not provide a subsequent command until receiving a success command or indication that the previous command was executed. Even though the second command is buffered for later execution (514), a success message indicating that the second command was successfully executed may be provided to the operating system layer 102 (516). In this manner, a third camera module independent command for initializing the primary camera 204 may be received from the operating system layer 102 before the second command is executed (518). The third command may then be translated into one or more camera module specific commands for initializing the primary camera 202 of the multiple camera module 202 (520), and the one or more camera module specific commands translated from the third command may be provided to the multiple camera module (522), while the second command is still buffered and not executed. Additional commands for initializing the auxiliary camera 206 may be buffered, and the subsequent commands for initializing the primary camera 204 may be executed. In this manner, the primary camera 204 may be initialized before the auxiliary camera 206.

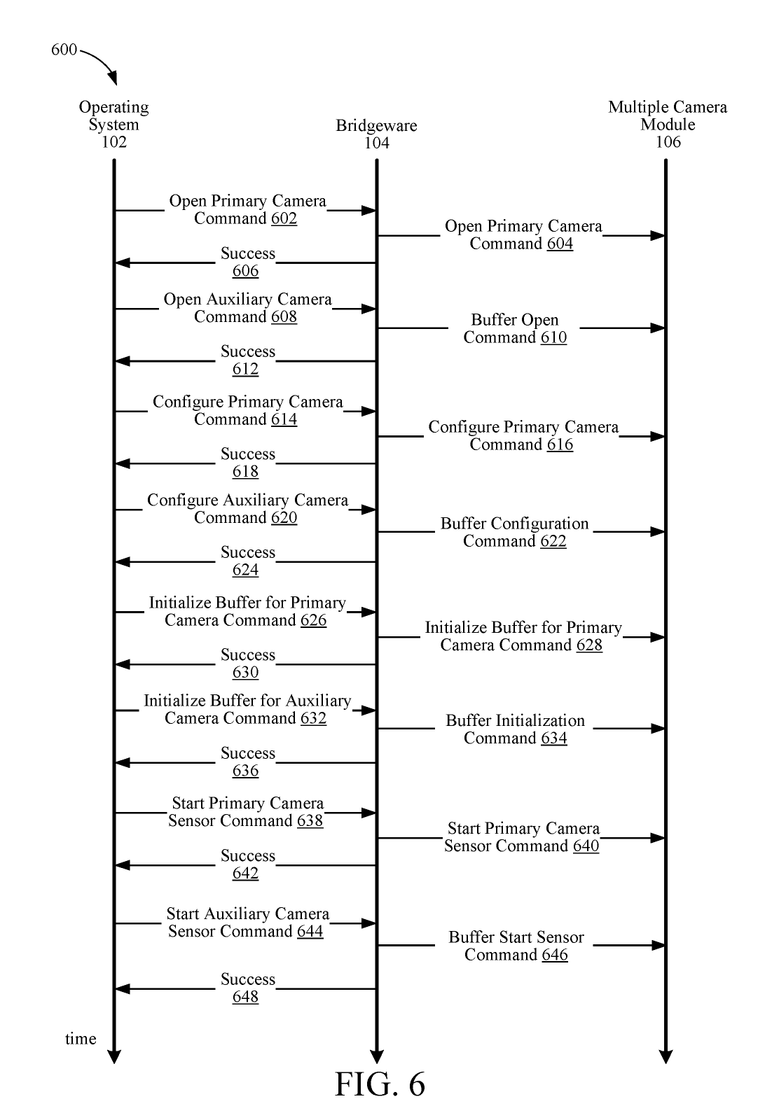

FIG. 6 is a timing diagram of an example initialization process 600 of a primary camera (such as a first camera 204) of the multiple camera module 202. In the example initialization process 600, the commands for initializing the auxiliary camera (such as the second camera 206) are buffered until the primary camera 204 is initialized. In some other example implementations, the device 200 may determine if one or more buffered commands may be executed before another command for initializing the first camera 204 is to be executed. For example, the device 200 may determine if sufficient downtime or processor idle cycles exists before the next command so that one or more of the buffered commands may be executed.

The camera module independent commands 602, 608, 614, 620, 626, 632, 638, and 644 of FIG. 6 are similar to the commands 302, 308, 314, 320, 326, 332, 338, and 344, respectively, of FIG. 3, the success indications 606, 612, 618, 624, 630, 636, 642, and 648 of FIG. 6 are similar to success indications 306, 312, 318, 324, 330, 336, 342, and 348, respectively, of FIG. 3, and the commands for initializing the primary camera 604, 616, 628, and 640 of FIG. 6 are similar to the commands 304, 316, 328, and 340, respectively, of FIG. 3. However, instead of the commands 308, 320, 332, and 344 for initializing the second camera being executed when received as depicted in the conventional initialization process 300 of FIG. 3, the commands 608, 620, 632, and 644 depicted in the initialization process 600 of FIG. 6 may be buffered (610, 622, 634, and 646, respectively) while the commands 602, 614, 626, and 638 for initializing the primary camera are executed. In this manner, a success message may be provided to the operating system layer 102 for each of the commands 608 (610), 620 (622), 632 (634), and 644 (646) without executing such commands. In some example implementations, commands 608, 620, 632, and 644 are executed after initializing the primary camera. In this manner, the auxiliary camera may be initialized during operation of the primary camera.

While all of the commands 608, 620, 632, and 642 are shown as being buffered before being executed, a subset of the commands may be buffered before execution. For example, one command may be buffered before executing the commands for enabling the auxiliary camera. The present disclosure should not be limited to a specific number of commands to be buffered. Additionally, while the timing diagrams show the commands being buffered before translation, one or more commands may first be translated into camera module specific commands, and the camera module specific commands are buffered for later execution. The present disclosure should not be limited to buffering the camera module independent commands. Furthermore, the present disclosure should not be limited to the described commands, as the commands are provided only for the purposes of describing the present disclosure.

When deferring execution of one or more commands for initializing a second camera 206, a success message or other indication may be provided for each of the deferred commands to pretend that execution of the corresponding command was successful. The deferred commands are then later executed to initialize the second camera 206. However, an error may occur when executing one of the deferred commands, even though a success message was previously provided for the deferred command. In some example embodiments, the multiple camera module 202 may be disabled (thus disabling the first camera 204) and the process for initializing the first camera 204 being repeated in initializing the multiple camera module 202.

For example, a buffer may have one or more commands queued for initializing the second camera 206. After initializing the first camera 204, the one or more queued commands may be executed in order to initialize the second camera 206. However, if one of the commands fails to execute, the multiple camera module 202 may provide an error message indicating the execution failure. In some example implementations, the bridgeware 104 may be used to indicate a hardware error for the multiple camera module 202 to the operating system layer 102. For example, the operating system layer 102 error message may be converted to an application specific error message for the camera application of the operating system 102 (such as by the HAL of the operating system 102). The camera application may thus be used to provide a close camera command for disabling the multiple camera module 202 in response to the error message, the HAL of the operating system 102 may be used to convert the command to a camera module independent command for disabling the multiple camera module, and the bridgeware 104 may be used to translate the camera module independent command to one or more camera module specific commands for disabling the multiple camera module 202. Disabling the multiple camera module 202 may include clearing or flushing the buffer of deferred commands for initializing the second camera 206.

Once the multiple camera module 202 is disabled (including disabling the first camera 204 and disabling the second camera 206), the operating system 102 may be provided a success message for disabling the multiple camera module. In response, the device 200 may attempt to again initialize the multiple camera module 202. In one example, initialization of the first camera 204 before initialization of the second camera 206 is repeated. In another example, the device 200 may revert to initializing all of the cameras of the multiple camera module 202 concurrently.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium (such as the memory 210 in the example device 200 of FIG. 2) comprising instructions 212 that, when executed by the processor 208 (or the image signal processor 216), cause the processor or device 200 to perform one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as the processor 208 or the image signal processor 216 in the example device 200 of FIG. 2. Such processor(s) may include but are not limited to one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While the present disclosure shows illustrative aspects, it should be noted that various changes and modifications could be made herein without departing from the scope of the appended claims. For example, while the first camera 204 is described as being a primary camera and the second camera 206 is being an auxiliary camera in some example implementations, the first camera 204 and the second camera 206 may both be auxiliary cameras or the second camera 206 may be the primary camera. Additionally, the functions, steps or actions of the method claims in accordance with aspects described herein need not be performed in any particular order unless expressly stated otherwise. For example, the steps of the example operations and timing diagrams illustrated in FIGS. 3-6, if performed by the device 200, the camera controller 214, the processor 208, and/or the image signal processor 216, may be performed in a different order and frequency than as shown. Furthermore, although elements may be described or claimed in the singular, the plural is contemplated unless limitation to the singular is explicitly stated. For example, while initialization of one camera and delaying initialization of one camera is described, any number of cameras may be initialized or delayed. Accordingly, the disclosure is not limited to the illustrated examples and any means for performing the functionality described herein are included in aspects of the disclosure.

What is claimed is:

1. A device, comprising:
one or more processors; and
a memory coupled to the one or more processors and including instructions that, when executed by the one or more processors, cause the device to:
receive a first command for initializing a first camera of a multiple camera module;
receive a second command, after receiving the first command, for initializing a second camera of the multiple camera module;
receive a third command, after receiving the second command, for initializing the first camera; and
execute the first command and the third command before executing the second command.

2. The device of claim 1, wherein execution of the instructions in executing the first command and the third command causes the device to:
translate at least one of the first command or the third command to one or more multiple camera module specific commands for the first camera; and
provide the one or more multiple camera module specific commands to the multiple camera module.

3. The device of claim 1, further comprising the multiple camera module, wherein:
the first camera is a primary camera; and
the second camera is an auxiliary camera.

4. The device of claim 1, wherein execution of the instructions further causes the device to:
buffer the second command; and
provide an indication that the buffered second command is executed before executing the buffered second command, wherein receiving the third command is in response to providing the indication.

5. The device of claim 4, wherein execution of the instructions further causes the device to execute the buffered second command when no command for initializing the first camera is to be executed.

6. The device of claim 5, wherein execution of the instructions further causes the device to execute the buffered second command after initialization of the first camera.

7. The device of claim 5, wherein execution of the instructions further causes the device to:
determine that the buffered second command may be executed without delaying execution of commands for initializing the first camera; and
execute the buffered second command between execution of commands for initializing the first camera.

8. The device of claim 4, wherein execution of the instructions further causes the device to:
receive additional commands for initializing the second camera;
buffer one or more of the additional commands in the buffer; and
execute the one or more buffered commands for initializing the second camera after initialization and during operation of the first camera.

9. The device of claim 8, wherein execution of the instructions further causes the device to:
for each buffered command for initializing the second camera, provide an indication that the buffered command is successfully executed before executing the buffered command;
determine that a buffered command for initializing the second camera is improperly executed after providing the indication for the buffered command;
provide an indication to disable the first camera and the second camera in response to the determination;
receive one or more commands for disabling the first camera and the second camera in response to providing the indication to disable;
execute the one or more commands for disabling the first camera and the second camera; and
re-execute the first command for initializing the first camera after the first camera and the second camera are disabled.

10. The device of claim 9, wherein execution of the instructions further causes the device to again receive the first command after executing the one or more commands for disabling the first camera and the second camera, wherein re-executing the first command is in response to again receiving the first command.

11. The device of claim 1, wherein execution of the instructions further causes the device to:
provide an indication that the first command is executed after executing the first command, wherein receiving the second command is in response to providing the indication that the first command is executed.

12. A method for initializing first and second cameras of a multiple camera module, comprising:
receiving a first command for initializing a first camera of the multiple camera module;
receiving a second command, after receiving the first command, for initializing a second camera of the multiple camera module;
receiving a third command, after receiving the second command, for initializing the first camera; and
executing the first command and the third command before executing the second command.

13. The method of claim 12, wherein executing the first command and the third command comprises:
translating at least one of the first command or the third command to one or more multiple camera module specific commands for the first camera; and
providing the one or more multiple camera module specific commands to the multiple camera module.

14. The method of claim 12, further comprising:
buffering the second command; and
providing an indication that the buffered second command is executed before executing the buffered second command, wherein receiving the third command is in response to providing the indication.

15. The method of claim 14, further comprising:
receiving additional commands for initializing the second camera;
buffering one or more of the additional commands for initializing the second camera; and
executing the one or more buffered commands for initializing the second camera after initialization and during operation of the first camera.

16. The method of claim 15, further comprising:
for each buffered command for initializing the second camera, providing an indication that the buffered command is successfully executed before executing the buffered command;
determining that a buffered command for initializing the second camera is improperly executed after providing the indication for the buffered command;
providing an indication to disable the first camera and the second camera in response to the determination;
receiving one or more commands for disabling the first camera and the second camera in response to providing the indication to disable;
executing the one or more commands for disabling the first camera and the second camera; and
re-executing the first command for initializing the first camera after the first camera and the second camera are disabled.

17. The method of claim 12, further comprising:
providing an indication that the first command is executed after executing the first command, wherein receiving the second command is in response to providing the indication that the first command is executed.

18. A non-transitory computer-readable medium storing one or more programs containing instructions that, when executed by one or more processors of a device, cause the device to perform operations comprising:
receiving a first command for initializing a first camera of a multiple camera module;
receiving a second command, after receiving the first command, for initializing a second camera of the multiple camera module;
receiving a third command, after receiving the second command, for initializing the first camera; and
executing the first command and the third command before executing the second command.

19. The non-transitory computer-readable medium of claim 18, wherein execution of the first command and the third command comprises:
translating at least one of the first command or the third command to one or more multiple camera module specific commands for the first camera; and
providing the one or more multiple camera module specific commands to the multiple camera module.

20. The non-transitory computer-readable medium of claim 18, wherein execution of the instructions further causes the device to:
buffer the second command; and
provide an indication that the buffered second command is executed before executing the buffered second command, wherein receiving the third command is in response to providing the indication.

21. The non-transitory computer-readable medium of claim 20, wherein execution of the instructions further causes the device to:
receive additional commands for initializing the second camera;
buffer one or more of the additional commands for initializing the second camera; and
execute the one or more buffered commands for initializing the second camera after initialization and during operation of the first camera.

22. The non-transitory computer-readable medium of claim 21, wherein execution of the instructions further causes the device to:
for each buffered command for initializing the second camera, provide an indication that the buffered command is successfully executed before executing the buffered command;
determine that a buffered command for initializing the second camera is improperly executed after providing the indication for the buffered command being executed;
provide an indication to disable the first camera and the second camera in response to the determination;
receive one or more commands for disabling the first camera and the second camera in response to providing the indication to disable;
execute the one or more commands for disabling the first camera and the second camera; and
re-execute the first command for initializing the first camera after the first camera and the second camera are disabled.

23. The non-transitory computer-readable medium of claim 18, wherein execution of the instructions further causes the device to:
provide an indication that the first command is executed, wherein receiving the second command is in response to providing the indication that the first command is executed.

24. A device, comprising:
means for receiving a first command for initializing a first camera of a multiple camera module;
means for receiving a second command, after receiving the first command, for initializing a second camera of the multiple camera module;
means for receiving a third command, after receiving the second command, for initializing the first camera; and
means for executing the first command and the third command before executing the second command.

25. The device of claim 24, wherein the means for executing the first command and the third command comprises:
means for translating at least one of the first command or the third command to one or more multiple camera module specific commands for the first camera; and
means for providing the one or more multiple camera module specific commands to the multiple camera module.

26. The device of claim 24, further comprising:
means for buffering the second command; and
means for providing an indication that the buffered second command is executed before executing the buffered second command, wherein receiving the third command is in response to providing the indication.

27. The device of claim 26, further comprising:
means for receiving additional commands for initializing the second camera;
means for buffering one or more of the additional commands for initializing the second camera; and
means for executing the one or more buffered commands for initializing the second camera after initialization and during operation of the first camera.

28. The device of claim 27, further comprising:
means for providing, for each buffered command for initializing the second camera, an indication that the buffered command is successfully executed before executing the buffered command;
means for determining that a buffered command for initializing the second camera is improperly executed after providing the indication for the buffered command being executed;
means for providing an indication to disable the first camera and the second camera in response to the determination;
means for receiving one or more commands for disabling the first camera and the second camera in response to providing the indication to disable;
means for executing the one or more commands for disabling the first camera and the second camera; and
means for re-executing the first command for initializing the first camera after the first camera and the second camera are disabled.

29. The device of claim 24, wherein:
the first camera is a primary camera; and
the second camera is an auxiliary camera.

30. The device of claim 24, further comprising:
means for providing an indication that the first command is executed after executing the first command, wherein receiving the second command is in response to providing the indication.
